(19) United States
(12) Patent Application Publication
(10) Pub. No.: US 2005/0116462 A1
(43) Pub. Date: Jun. 2, 2005

(54) Removably attachable security devices

(76) Inventor: Jon B. Telleen, Boulder, CO (US)

Correspondence Address: JAMES K. POOLE, ESQ., P.O. BOX 925, LOVELAND, CO, 80539, US

(21) Appl. No.: 11/007,619

(22) Filed: Dec. 7, 2004

Related U.S. Application Data
(62) Division of application No. 10/657,880, filed on Sep. 9, 2003.
(60) Provisional application No. 60/417,713, filed on Oct. 9, 2002.

(51) Int. Cl. G09F 1/00

(52) U.S. Cl. 283/56; 206/38.1; 340/5.6; 705/14

(57) ABSTRACT

Security devices which are detachable or removably attachable are provided for keeping access means to particular spaces separate from identification means for the spaces. The devices can be removably attached to holder assemblies for the access means, e.g. a holder for a hotel room key or the like, preferably with incentives provided for the user to separate the access means from the identification means for security reasons. A business method for selling advertising for inclusion in such holder assemblies, sorting editing the resulting advertising copy, printing holder assemblies for particular facilities and distributing same to the facilities is also disclosed.

### REFERENCE TO RELATED APPLICATION

This application claims priority from Applicant's provisional application, U.S. Ser. No. 60/417,713 for REMOVABLY ATTACHABLE SECURITY DEVICE, filed Oct. 9, 2002, which is incorporated herein by reference in its entirety.

### BACKGROUND OF THE INVENTION

1. Field of the Invention

The present invention relates to detachable security devices which associate a number, alphanumeric code and/or symbol with personal access to a space, e.g. a detachable tab recording a hotel room number or the like which can be removed from a folder or other portable holder or container for the associated room key and/or other valuables, or from the access device itself. The invention further relates to incentives provided for removing and safeguarding the security device, such as a prize, an entry in a raffle or other game of chance or reward system.

2. Description of Relevant Art

Personal security is becoming increasingly important in both business and leisure travel. Many hotels provide coded plastic room keys in small envelopes or folders, and sometimes mark the room number and even the guest's name on such holders. Applicant has personally observed such practices, and recognized the security hazards inherent in having a room key associated in a small package with the guest's name and/or room number. In the event such an assembly is lost or stolen, the recipient could obtain immediate access to the room, at least until the hotel is able to alter the lock and issue a new key. This practice may intended as a convenience for the guest who may not remember a room number which is whispered to him or her upon check-in, and does not utilize a bellman to locate and open the assigned room. The hazard arises if the guest keeps the room key in a container displaying the room number and loses this container with both key and room number, thus giving the finder both access and entry to a particular room. Loss of documents including room number and the guest's name can also be hazardous, allowing the finder to contact the room directly via house or outside phones to determine if the guest is in the room. Similarly, the loss of keys to a rental vehicle with an identification tag attached could provide the finder with means to identify the vehicle and to acquire both access and unauthorized use of same.

Applicant's experience and interest in the fields of security, advertising, coupon sales and gaming suggested that some sort of marketing network could be employed to support systems including holders, carriers or other assemblies including hotel room keys (or other access devices) which are more secure for both guest and hotel. Such systems could be designed to fulfil needs in many areas of the transportation, hospitality and entertainment industries in addition to hotels.

Numerous prior art patents deal with locks, keys and other security devices. For example, U.S. Patent No. 4,488,737 discloses a combined key holder and booklet, the booklet including space for writing the room number. Advertising materials can be included in the booklet. A detachable envelope can be included for transmitting comments to the hotel and/or ordering goods or services advertised in the booklet. In the background, the patent describes the perceived inconvenience of a hotel guest having to maintain a room key, printed material about the hotel and the room number as separate items.

U.S. Pat. No. 5,529,172 discloses entry means holders for removably holding a hotel room key or key card, the room number and/or guest's name being recorded on the holder for identification of the room number to the guest and/or of the guest to hotel staff. Detachable portions of the holder can provide for the identification of additional room occupants and/or contain coupons, advertisements or the like, to be used in conjunction with the ID. There appears to be no incentive for the guest to separate the unmarked key from the holder.

U.S. Pat. No. 3,225,478 discloses a key tag or key head cover designed to be marked with the key identification and applied to the key head by adhesive means. There is no suggestion of removing the tag once marked and applied.

U.S. Pat. No. 4,336,701 discloses a keying process for resettable locks in which individual keys are identified by permanently inscribed serial numbers and removable plugs in the key head or handle indicating the hotel room number whose lock has been set to accommodate that key. There is apparently no suggestion or motivation for the guest to remove the plug (and room number) from the key; this is to be performed by maintenance when the individual room locks are re-keyed. Furthermore, the permanent inscription of the serial number on the key affords an advantage to those who might take an impression of the key for later duplication and improper use.

U.S. Pat. No. 4,907,359 discloses a simple key tag which can be imprinted with information and optionally removed from the key or key ring.

U.S. Pat. No. 5,232,528 discloses a method for semi-permanent attachment of ID labels (preferably containing a bar code) to conventional keys or key blanks to facilitate inventory control in a retail store or the like. The assembly would have to be removed for cutting a blank into a key or using the key.

U.S. Pat. No. 1,979,960 discloses automotive ignition keys which include breakaway tags containing the manufacturer's code number for the locks to which they apply. The tags are designed to inconvenience the user unless they are removed, thus preventing anyone other than the vehicle owner from discovering the combination of the lock by use of the code number and locksmiths' code charts.

U.S. Pat. No. 4,565,922 discloses key card apparatus employing series of electrical conductors inside the card which can be selectively severed by external drilling to incorporate a specific code. The cards are described as less vulnerable to damage or magnetic influences than conventional cards containing electronic circuit components or magnetic information therein.

U.S. Pat. No. 4,801,076 discloses advertising pouch assemblies intended for distributing advertising literature and the like, plus methods for assembling same. Although the pouches contain numerous slits, pockets and the like for holding literature and business reply cards, there is no disclosure or suggestion of incorporating access means such as room keys.

U.S. Pat. No. 6,234,477 discloses integrated lottery pouches, designed to contain at least two lottery tickets therein. Methods of variable printing and assembly of the tickets and pouches are disclosed.

U.S. Pat. No. 6,311,860, assigned to Taco Bell Corp., discloses a container closure for soft drinks and the like, designed to hold a game piece between an opaque shield and a sealing member which is removable to view and extract the game piece.

U. S. Pat. No. 6,523,824 discloses a “business model algorithm” which provides for the placement of advertising materials in place of the conventional icons displayed during the play of slot machines. This patent is incorporated herein by reference.

Despite increasing security problems in hotels and other areas where space numbers and access means are used in combination, there remains a need for convenient holders or carriers for access means which include incentives for the user to separate the access means from the room number or other space number. Little effort seems to have been made by the industry to apply the principles of the advertising or gaming industries to provide such incentives and improve the security and safety of the hotel guest or other users of the transportation and hospitality industries.

### SUMMARY OF THE INVENTION

It is an object of the present invention to provide means and incentives for a traveller, whether hotel guest or passenger on common carriers including passenger trains and ships, to maintain the identity of his room number or other location identification and the means of access thereto (such as a key) secure and separate. It is another object of the invention to provide a variety of benefits to the traveller in a small folder or other holder for a room key or other access means, such as maps, advertising media incorporating discounts or other incentives, and the like. A further object is to provide removable security devices containing the room number or other location information which provide incentives for the removal of the device from the holder containing the key or other access means, e.g. immediate prizes, coupons or the like or the ability to turn the security device or a component thereof in (to the host activity) for rewards through a raffle or other game of chance. A further object is to provide advertising connections between a hotel, resort, casino, common carrier or other establishment accommodating travellers and local, regional or national vendors of goods and services to their mutual benefit. Still another object is to provide incentives for the traveller to visit, and preferably patronize, the advertisers listed in the key holder or other container. Yet another object is to provide at least one memento for the traveller to retain, which may contain contact information for the hotel, carrier and/or advertisers.

In accordance with the present invention, a carrier or holder assembly is provided for keys, codes, combinations or other access means to spaces for travellers such as hotel rooms. In addition to holding such access devices, the holder assembly comprises a detachable or removably attachable security device containing at least the room number or other locating information for the space. Incentives are preferably provided for the user to separate the security device or space information portion thereof from the access means, including at a minimum instructions to do so for the user's personal security. The holder preferably also includes advertising and useful information such as maps of the hotel, other establishments or local areas of the city, with key landmarks and attractions marked; discount coupons or other incentives providing guidance to selected local advertisers; currency conversion tables, local transportation schedules, rates and the like; and pictorial materials such as postcards. This informative material can be in printed form and/or embodied in “writable” electronic media such as mini-compact discs which may be read in laptop or desktop computers. Such media can embody programs which facilitate communication with the hotel or other establishment to check out, order special services such as tours, make future reservations and the like.

Either the holder or the security device could include keepsake or souvenir items such as pictorial refrigerator magnets, souvenir coins or tokens, costume jewelry such as pendants, and the like. The removable security device can contain additional numbers, alphanumeric codes or symbols, including advertising media, which can be communicated to the hotel, carrier or other organization to qualify the traveller for prizes or premiums. For example, the assigned room or space number can be the basis for an entry in a raffle if the device is deposited with the institution when checking out or disembarking. Using numbers or other codes randomly assigned upon checking in or embarking upon a trip, a computerized system can be used to make selections for prizes at any time, even daily or hourly. In resorts or casinos offering gambling, a computerized system can be used to qualify such codes for chances on large jackpots or other prizes, as is now done with slot machines in certain casinos. The traveller would be required to present the security device or a portion thereof to confirm his assigned code and claim the prize, encouraging him to keep the security device safe (i.e., separate from access means) and available at all times. This concept could be effectively applied to convention groups, cruises, reunions, tours or other groups travelling together to encourage full attendance and personalized participation in scheduled activities. A portion of the device can also be used as an ID to identify the holder as a guest of the hotel or other issuer. In addition or as alternatives to numbers or codes, certain combinations of advertising materials can be used to qualify the recipient for a prize or award, as in U.S. Pat. No. 6,523,824, which is incorporated herein by reference. Such a system will further motivate the traveller, guest or ultimate user to pay more attention to the advertising.

In a basic embodiment, the invention comprises access means to a space in combination with a detachable or removably attachable security device comprising identification means for the space, which security device preferably prevents use of the access means until the device is removed. Such combinations can include access means such as card keys, various types of mechanical keys and combinations for combination locks imprinted upon suitable media, with the security devices containing at least one component selected from peelable adhesive labels, strips of sheet material such as paper, plastics, fabrics and the like, which can be arranged or attached to prevent use of the access means until their removal. Access means to a vehicle, whether conventional mechanical ignition and/or door keys or ignition keys including wireless signal transmitter to lock and unlock the doors can include a removable vehicle ID tag. This can be accomplished by conventional dual, detachable key rings or other suitable connections. Removal of the ID tag would prevent a person finding lost keys from identifying them with the vehicle. Furthermore, when used with keys including wireless lock actuators, the removal of the ID tag can be adapted to break an electrical circuit to disable the transmitter.

Another embodiment of the invention is a business method comprising steps of selling advertising to national, international regional or local providers of goods and services such as those connected with a hotel, hotel chain or group, a resort, a passenger cruise line, passenger railroad or other entity accommodating travellers; producing carriers or holders for keys or other devices providing access to a hotel room, shipboard cabin or other designated space, the holders incorporating detachable security devices identifying each room or other space number so that it can be detached and kept secure and separate from the key holder; including in the key holder and/or security device printed matter such as advertising, maps and guides to local attractions and other incentives for the traveller to keep both the key holder and the security device; providing numbers, alphanumeric codes or symbols, optionally including various advertising materials, on the security device which can be communicated by the traveller to the hotel, carrier or other source to qualify for incentives such as prizes, discounts, and the like; and rewarding the traveller accordingly for keeping the security device secure and communicating a code to a designated receiver. The traveller can also be rewarded for visiting and/or patronizing certain numbers of the advertisers. On a small and simple scale, this method can be carried out in a manner resembling the use of serially numbered tickets for door prizes at various public functions.

Preferably, the system is at least partially computerized and automated, so that numbers, advertising materials or alphanumeric codes are generated randomly for use on the security devices, and prizes are periodically assigned to codes selected at random. This information could be communicated by various means to the traveller via his hotel room, telecommunications media, e-mail, postings on a website, bulletin board or the like, closed-circuit TV or public address systems. Alternatively, the traveller could have his security device code read by an electronic reader or otherwise communicate with a centralized, frequently-updated listing of awards (e.g. on an internet website or hotel TV channel) to learn about awards for which he is eligible and how to claim them. Many of these storage, computing and communications media are commercially available, and even small modern computers can easily be programmed to carry out such functions by those skilled in the computer programming and data processing arts.

### BRIEF DESCRIPTION OF THE DRAWINGS

The foregoing summary, as well as the following detailed description of preferred embodiments of the present invention, including the objects and advantages thereof, will be better understood when read in conjunction with the following drawings and the appended claims.

FIG. 1 is a front perspective view of a trifold multipurpose card and holder for a plastic hotel room key.

FIG. 2 is a rear perspective view of the holder of FIG. 1.

FIG. 3 is a front perspective view of a bifold key holder.

FIG. 4 is a rear perspective view of the holder of FIG. 3.

FIGS. 5A, 5B and 5C are front perspective views of bifold holders with double, single and curved keyholder slots.

FIG. 6 is a front perspective view of a multifold multipurpose card and holder for plastic hotel room card keys and other items.

FIG. 7 is a rear perspective view of the holder of FIG. 6.

FIGS. 8A and 8B are front and rear views of a closed envelope key holder with a perforated flap.

FIGS. 8C and 8D are front views of an open envelope key holder with a perforated tear-off tag in place and removed.

FIG. 9 is a front view of a card adapted to hold a metal key with die-cut tab and slit.

FIGS. 10A, 10B and 10C are front views of a pouch-style envelope key holder with a perforated coupon attached and detached (10C).

FIGS. 11A and 11B are front views of a pocket-style key holder with a card key or flat metal key retained therein by an adhesive label.

FIGS. 11C and 11D are front views of a pocket-style key holder having die-cut slots for special inserts.

FIGS. 11E and 11F are front views of a pocket-style key holder and a a paper strip which is folded over the card key placed in the holder.

FIG. 11G is a front view of a pocket-style key holder with a card key secured therein by an adhesive or wax seal.

FIGS. 12A, 12B and 12C are front views of card keys and conventional keys with adhesive room number labels directly affixed to the keys. FIG. 12D is a detail view of the use of such labels to conceal valuable tokens or the like.

FIGS. 13A and 13B are front and rear views of a card key encircled by a paper sleeve with interlocking die-cut ends,

FIGS. 13C and 13D are front and rear views of a card key encircled by a paper sleeve whose ends are fastened together by a seal.

FIGS. 13E and 13F are front and rear views of a conventional flat metal key which is wrapped in a paper strip which is die-cut to accommodate the stem of the key and provide interlocking ends.

FIGS. 14A and 14B are front views of a card key with an adhesive label affixed and the label itself with a “scratch-off” coating partially removed.

FIGS. 15A and 15B are front views of a pouch-style key holder containing a card key, showing an adhesive label applied to retain the key in the holder and then removed.

FIG. 15C is a front view of a pouch-style key holder with a flat metal key affixed to the outside of the holder by an adhesive label.

FIGS. 16A, 16B and 16C are front views of a pouch-style key holder containing a card key with an adhesive label affixed to protrude from the holder; the card key removed from the holder; and a flat metal key with an adhesive label similarly applied.

FIG. 17 is a front view of a pouch-style key holder containing a card key, the key being retained within by a ribbon and adhesive label.

FIG. 18 provides front views of a pouch-style key holder containing a card key and a paper slip in a slit, plus the paper slip removed, with front and rear views.

FIGS. 19A and 19B are front views of a pouch-style key holder containing a card key, a room number slip being attached to the exterior with staples or paper clips.

FIGS. 20A and 20B are front views of a pouch-style key holder containing a card key, the key being retained in the holder by a money clip applied to the pouch opening, and the money clip removed and in use.

FIGS. 21A and 21B are rear views of an envelope-style key holder containing a card key, with a tear-off flap providing access to the key,

FIGS. 22A and 22B are rear views of an envelope-style key holder having a flap held closed by string wrapped around circular fasteners, and the string separated from the envelope and containing a room number card and prize.

FIG. 22C is a rear view of an envelope-style key holder with a clasp-type flap held closed by the clasp, a room number card also being held in place by the clasp.

FIGS. 23A and 23B are front views of a trifold-type envelope key holder in both closed and open positions.

FIG. 24 is a schematic diagram illustrating a business method of the invention.

### DETAILED DESCRIPTION OF PREFERRED EMBODIMENTS

Devices for providing access to the designated space can be of any suitable type for the industry, including conventional keys having flat or “skeleton” key shapes, codes for computerized numerical pads placed on or near the access door, and magnetic devices including conventional plastic “card keys” which release a lock when inserted into a slot in the correct manner. Psychometric or electrooptical devices can also be programmed to recognize the fingerprint, voice, eye characteristics, personal walking gait or other physical attribute of the user assigned to the particular space. Wireless transmitting devices can be provided to lock and unlock doors for vehicles and other spaces.

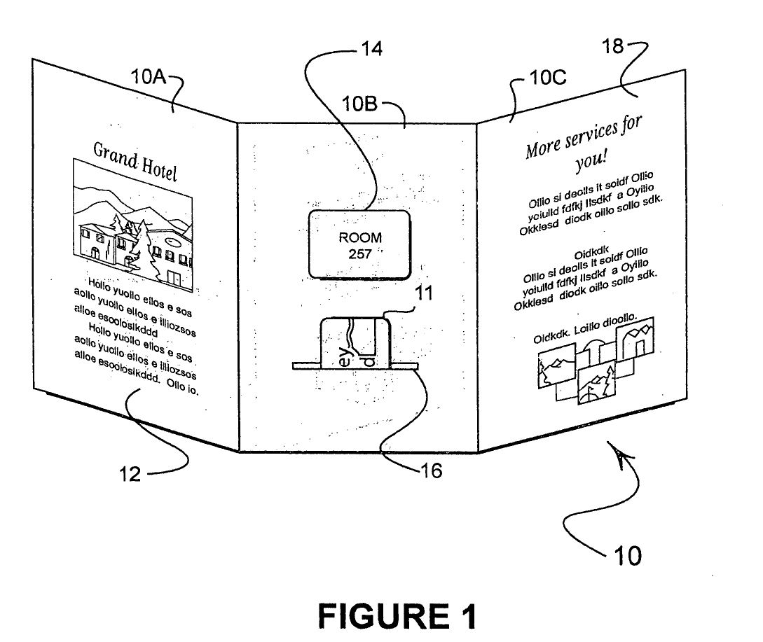

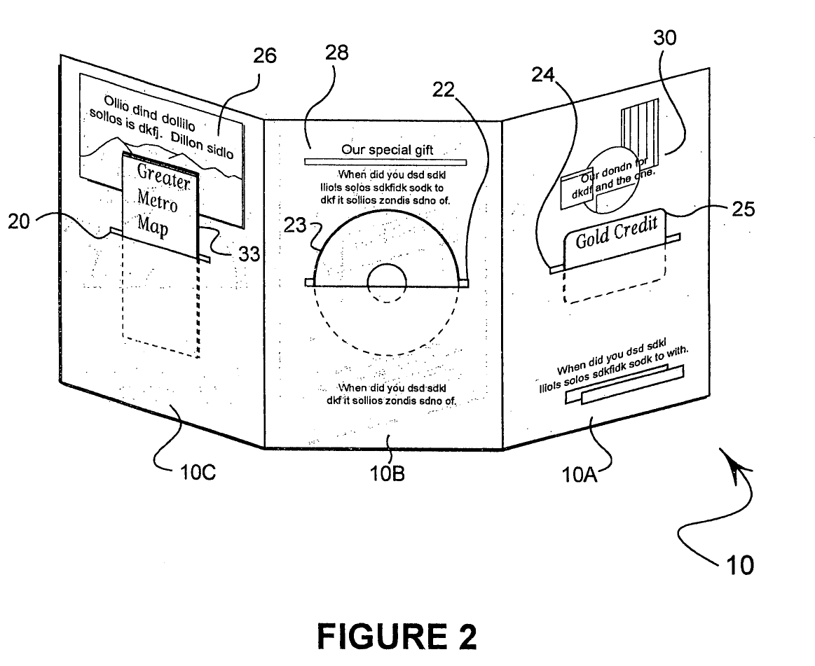

Referring now to the drawings, FIGS. 1 and 2 illustrate a trifold folding card and holder 10 for a flat plastic hotel room key (card key) 11, which is inserted in slot 16. Advertising material 12 for a hotel, common carrier or the like is printed on the left panel 10A in FIG. 1. A removable security patch 14 is provided in the middle panel 10B to carry a room number or the like separate from the key, with written and verbal instructions provided to the guest to stress this security procedure. At least one layer of advertising materials, rewards or prize codes can be revealed by removal of patch 14. More advertising material 18, e.g. for national organizations, is placed on the right panel 10C in FIG. 1. FIG. 2 reveals in the rear view of holder 10, in the left panel 10C a slot 20 for holding a map 33, slot 22 in the center panel 10B for a CD-ROM or other electronic media 23, and at least one slot 24 in right panel 10A for a credit card 25. A hotel guest ID (not shown here) could be combined with a prepaid credit card for hotel shops, restaurants and the like, and/or a prepaid telephone calling card. This facilitates the user carrying useful personal articles such as maps, guides, credit cards and the like separate from the room number identification. More advertising of various types can be positioned at positions such as 26, 28 and 30 behind the map, CD-ROM and credit card slots.

The holders described above and below can be formed of suitable sheet material by die cutting, printing and stamping. Such sheet material is preferably paper or card stock with a suitable degree of rigidity, ability to fold to form a stable crease and printable by automated printing systems known in the art. Various types of plastic sheet material comprising polymeric materials, reinforcing fibers and cellulosic materials can also be used, for example. Certain kinds of woven or nonwoven fabrics, barks or other natural fibers or sheet materials can be used to convey the theme of a resort or the like and provides a keepsake for the guest. Exterior panels or layers can be fastened to the holder, comprising smooth, semi-rigid materials including leather, wood, metal, plastics or polymeric composites.

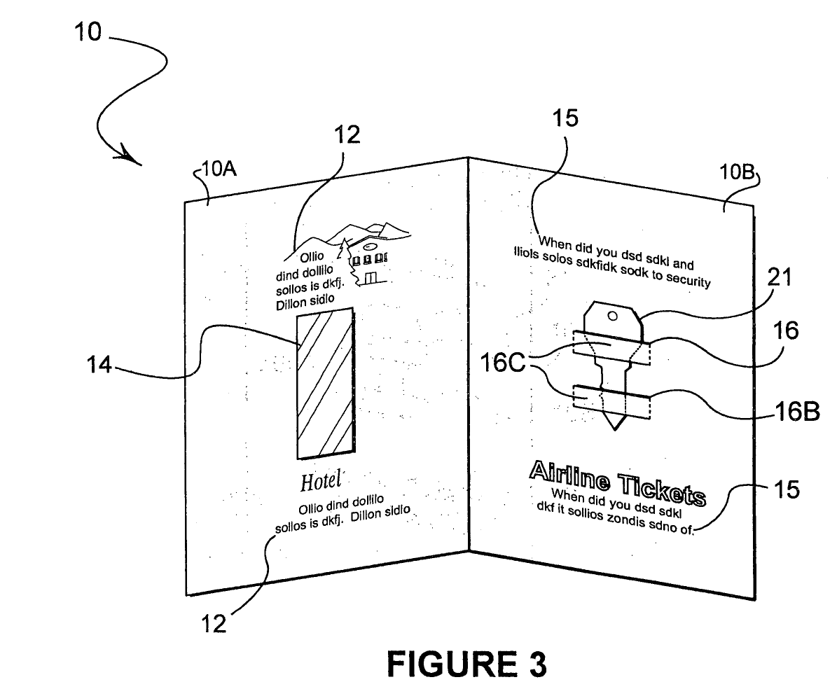

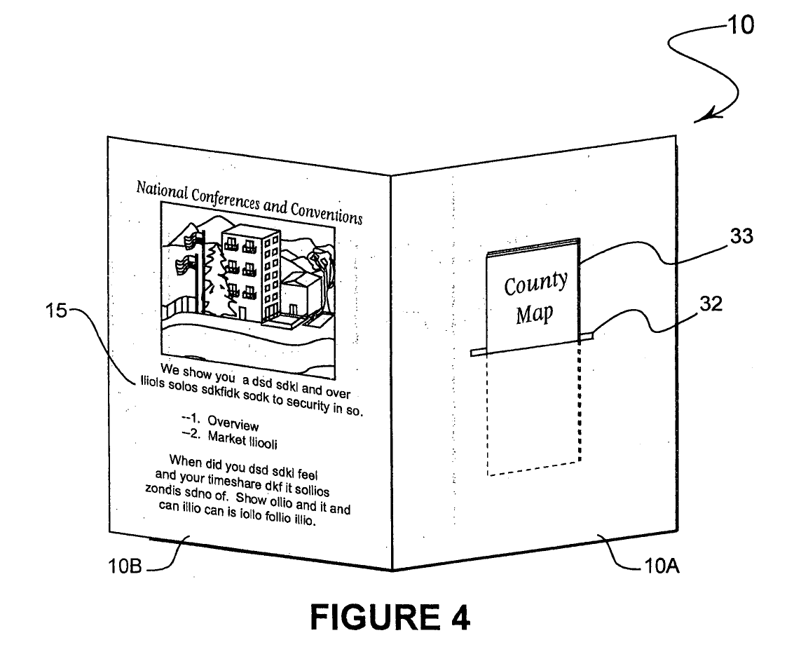

FIGS. 3 and 4 illustrate a simpler holder, a bifold version 10 with panels 10A and 10B. In FIG. 3, the front view reveals in left panel 10A a removable security patch 14 for the room number, and hotel or carrier advertising 12. The right panel 10B includes at least one keyholder slot 16 for a conventional metal key 21 and national advertising 15, which also appears on the left panel 10B of the rear view, shown in FIG. 4. The tabs 16C formed by slots 16 can be made removable by perforations 16B. The right panel 10A in FIG. 4 contains slot 32 for holding a folded map 33.

FIGS. 5A, 5B and 5C illustrate variations of the keyholder slots 16 of holder 10, with double slots/tabs 16 appearing in FIG. 5A, a single slot/tab 16 in FIG. 5B and a curved slot 16A in FIG. 5C. Any of these variations can be used to retain a conventional key until removal. Tabs formed by the slots can be perforated (as at 16B) for removal. Various types of adhesive seals can be used to hold the keys in place, either alone or in conjuction with the perforated tabs, requiring that the seals be unpeeled or broken to remove the key, as described elsewhere herein.

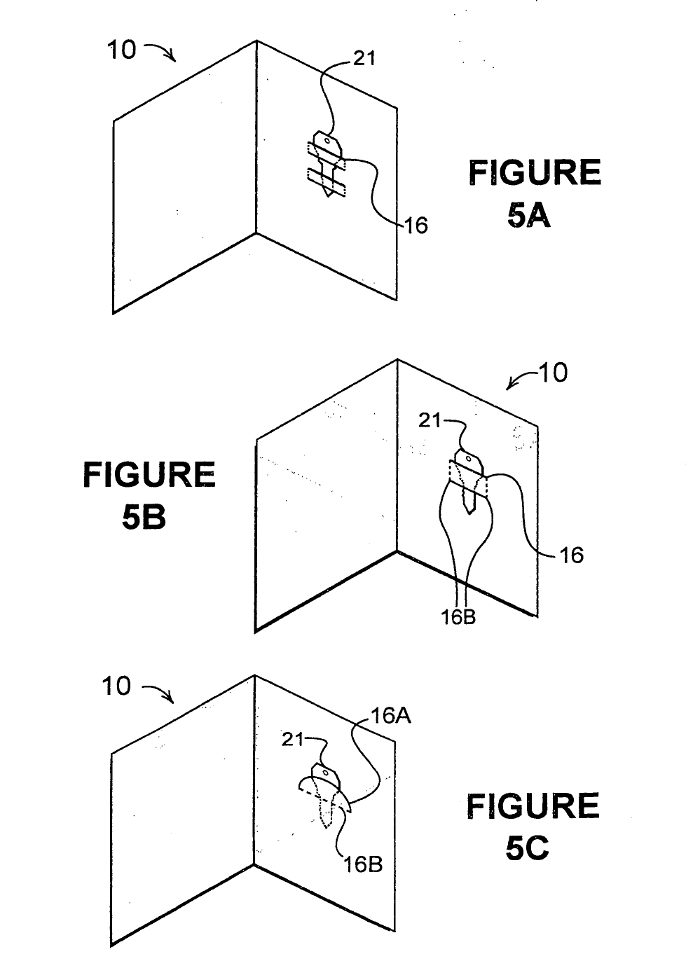

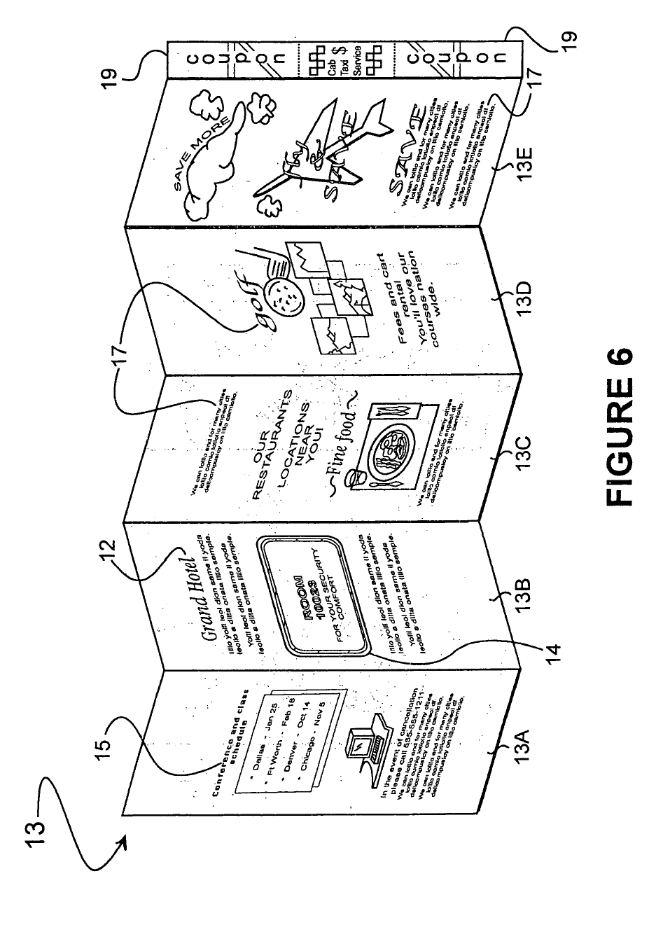

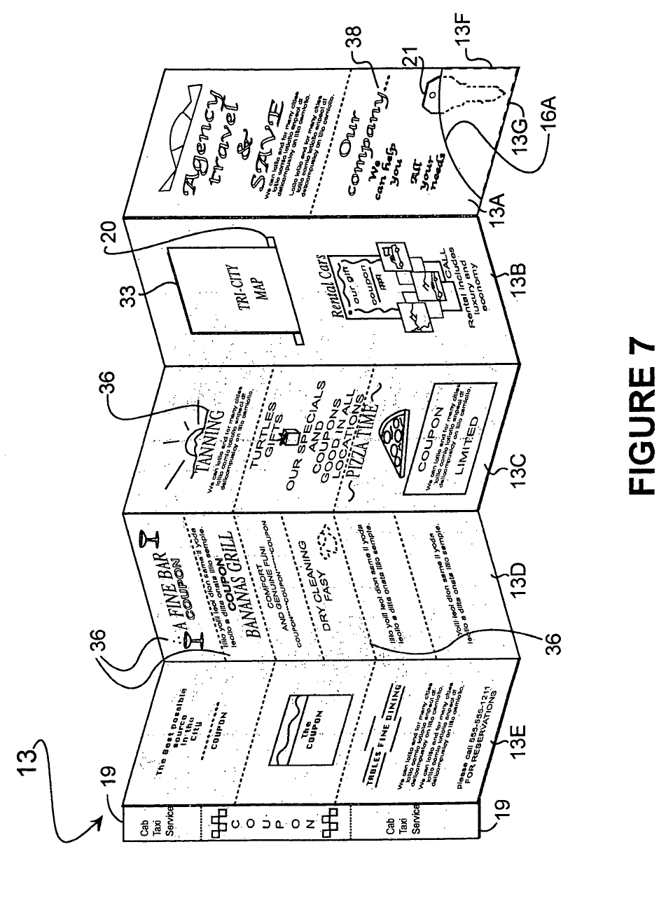

FIGS. 6 and 7 illustrate a multifold card and key holder 13 of the invention. The front view of FIG. 6 reveals national advertising 15 on the leftmost panel 13A. The second panel from the left (13B) includes a removable security patch 14 for the hotel room number and hotel advertising 12. The central panel 13C and the two panels to the right (13D,13E) can also contain general advertising 17 and detachable taxi discount coupons 19 or the like. The rear view of FIG. 7 illustrates in the rightmost panel 13A a curved slot 16A for a conventional room key 21 and advertising 38 by the system provider, i.e. the company publishing and distributing the cards/key holders. The straight edges 13F and 13G from slot 16A to the corner of panel 13A can be perforated (not shown here) to encourage removal of the tab thus formed (and key 21). Detachable taxi discount coupons can be placed on the leftmost panel 19, with various types of retail discount coupons 36 (local, regional, auto rental agencies, etc.) placed in the next three panels, {13E, 13D, 13C). A map slot 20, or even a printed, folded map 33, can be provided in the second panel from the right 13B. As an alternative to folded maps which are removable from slots or other retaining means, maps can be an integral part of the holder assemblies, having at least one edge attached to a panel of the holder and unfolding for use according to any suitable scheme known in the art.

The key holder or holder for access or entry means to any assigned space can take any suitable form, including a simple paper folder, pouch or envelope large enough for holding a typical plastic computer-coded card key, check-in receipts and the like, but can extend to multifold devices comprising paper, plastics, leather or metal containing useful items such as maps, currency conversion tables, transportation schedules and rates, discount coupons and other incentives provided by local advertisers. The paper stock or other sheet material used for printing can have at least two layers to facilitate the forming of slots and pockets to hold keys, cards and the like.

The information provided can be in conventional printed form and/or embodied in suitable electronic media such as mini-compact discs, including CD-ROMs. Commercially available microchip-based musical devices can be included to play suitable theme music when the holder is opened. Fragrances can also be incorporated in the holder and/or security devices. Miniature calculators programmed to facilitate currency conversions can also be included. With fashionable, expensive hotels, cruise ships or the like, the holder can be elegant and attractive enough to encourage the patron to retain it as a memento (and thus the contact information for the hotel or carrier and the local advertisers). It may be beneficial for local advertisers to maintain such contacts to facilitate later phone or mail orders for local delicacies, unique crafts or the like.

The removable security device carrying the room number or other location identification can be of any suitable shape, size, material or construction which is convenient for the traveller to carry and encourages secure storage. For example, with conventional hotel key holders or folders, the security device can be a small paper tab perforated for easy removal or a label which can be attached to the folder with a suitable pressure-sensitive adhesive so that the traveller can peel it off, then fold the label to adhere the adhesive back portions together while leaving the room number visible. Alteratively, the label could be adhered to the label with a gelatinous pressure sensitive adhesive which could be removed from both surfaces by rubbing. The device could also take the form of a slip of paper or card stock which could be withdrawn from a slit or other suitable repository in the holder and folded for convenient storage in pocket, wallet or purse, with the room number concealed until it is unfolded. In many cases it will be convenient to use a small card about the size of a business card. The device could also be removably attached to the holder by mechanical or magnetic attachment means such as hook-and-loop fabric combinations (e.g., VelcroTM) or magnetic portions in both holder and device. In the latter instance, the device could take the form of an attractive souvenir “refrigerator magnet”, with the room number marked upon the back.

The device could also be a decorative piece suitable for wear as a woman's pendant or brooch, attached to the holder by a gelatinous pressure-sensitive adhesive which can be completely removed from the piece by friction. The device can also be embodied in other useful items such as simple money clips, mini-purses or wallets (suitable for carrying foreign currency, travellers' checks, business cards or the like), or small notepads. Many of these devices could have the room or space number revealed only by an opaque “scratch off” material (as in a lottery card), ink which either appears or disappears after a short period of time, or other methods to conceal the number until the traveller is able to step away from a crowded registration desk. The removable security device and/or key holder can be custom-printed to identify and include theme symbols for a special tour, reunion, convention or the like. Similar information and/or advertising can also be printed on card keys.

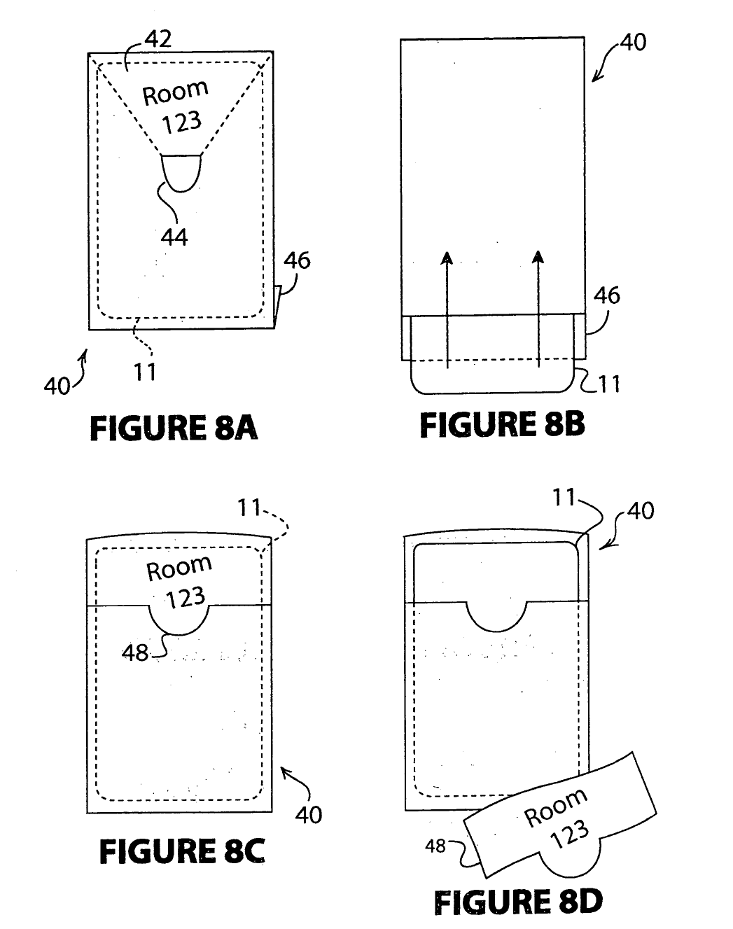

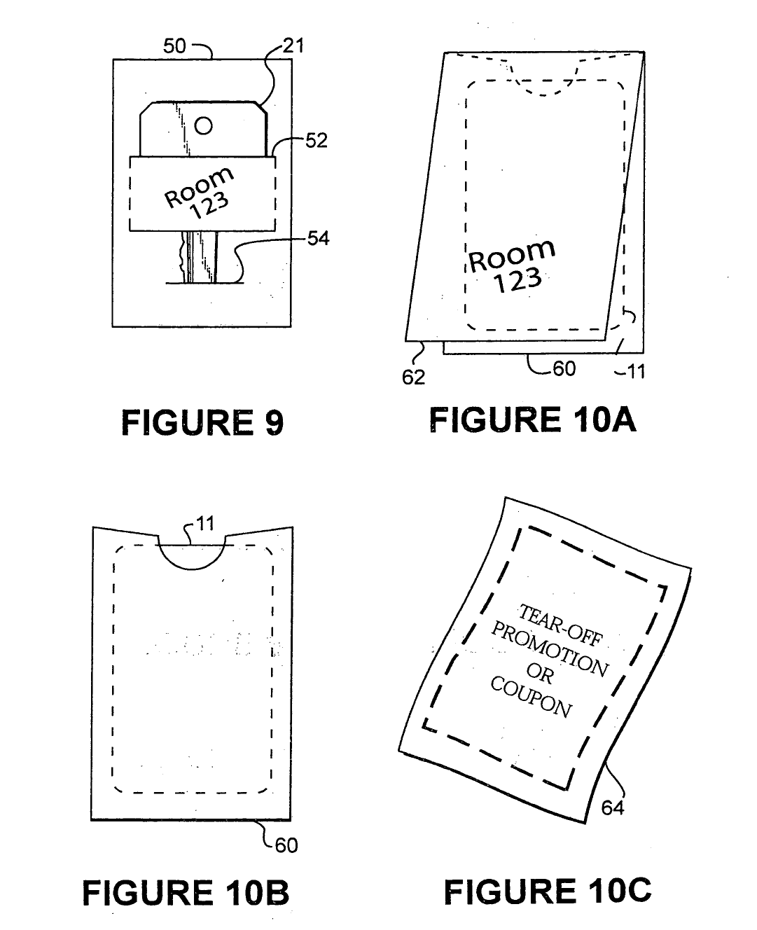

As shown in FIGS. 8A and 8B, a magnetic card key 11 can be enclosed inside a sealed envelope 40, a perforated tear strip 42 with a graspable tab 44 being provided for recording of the space or room number, the tab and room number to be kept separate from the card key-containing envelope once it is removed. FIG. 8B illustrates the insertion of the card key 11 into the envelope 40 (reverse side shown), which is then sealed by removing a protective strip from a strip of strong pressure sensitive adhesive (similar to that used in various express shipment envelopes, but not shown here) and folding and pressing the flap 46 to adhere it to the envelope, sealing the latter. This can be done in the process of producing the key holder, or just before the assembly is delivered to the ultimate user at the hotel or other facility. FIGS. 8C and 8D illustrate the envelope 40 with the perforated tab 42 removed and the card key 11 retained in the envelope. Also shown is a small tab 48 which is removably attached to the envelope, containing the room number and representing various types of discount coupons, admission tickets, chips or tokens which can be offered for the use of the registered guest. FIG. 9 illustrates a perforated die-cut card 50 providing a perforated sleeve 52 and slot 54 to retain a conventional flat metal key 21. The tab or card can be inserted in an envelope as previously described, presented to the guest as is, or included as one panel of a multifold holder. When the perforated sleeve portion with the room number recorded thereon is removed, the key is freed for use and the sleeve becomes a small, separate tab which can be retained separately to safeguard the room number. Card 50 cam be imprinted to serve as a hotel ID, carry discount coupons, advertising or the like.

A pouch-style envelope 60 with a removable coupon 64 attached is shown in FIGS. 10A, 10B and 10C. A card key 11 is contained within a small keyholder envelope 60 with the opening of the envelope being covered by perforated flap 62 upon which a room number can be marked. Instructions to remove the flap can be printed on the reverse side, which preferably also includes a coupon 64, advertising or promotional message encouraging the user to separate the flap and coupon from the keyholder. The coupon 64 can be at least partially attached to the underside of flap 62 by a peelable pressure sensitive adhesive. Such coupons can comprise multiple portions separable along perforated lines and/or multiple layers which adhere removably together by means of pressure-sensitive adhesives or other suitable means.

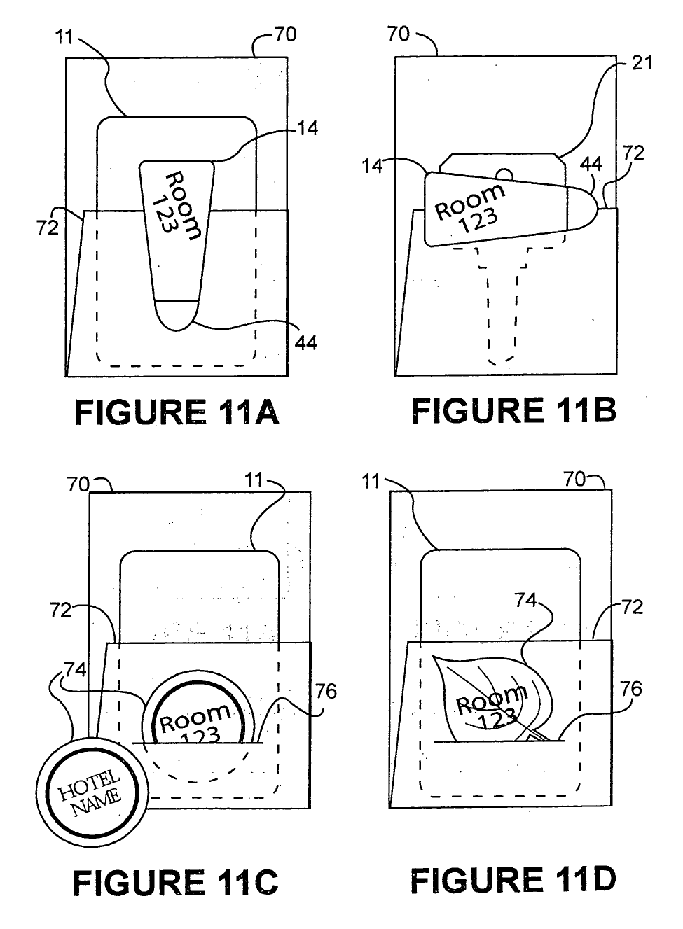

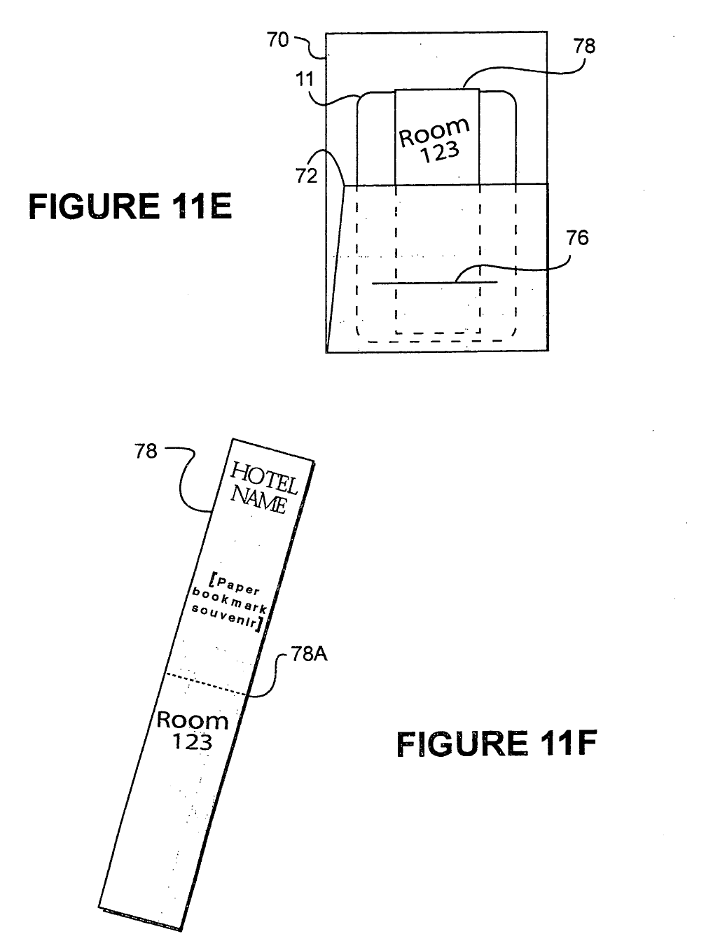

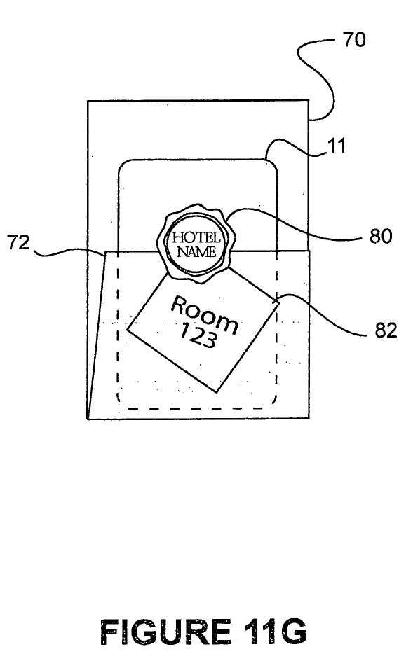

As shown in FIGS. 11A and 11B, a room number can be marked upon a peelably removable adhesive label 14, preferably including a small non-adhesive pull tab 44 at one end, which is then affixed to both the key (e.g., a card key 11 or flat metal key 21 as shown) and the key holder 70 in which the key is held by a pocket 72 or slot (not shown here) arrangement. The card key or metal key is thus retained within the key holder 70 until the adhesive label 14 is removed. The room number should be marked upon only a portion of the label, so that the adhesive portions of the label can be folded to adhere together, leaving the room number visible to the user. (Alternatively, a gelatinous adhesive which is easily removable can be used).

FIGS. 11C and 11D illustrate a similar key holder with an open pocket 72 for holding a key, the room number being marked upon a removable piece 74 such as a disc which is inserted in a die-cut slot 76 in the pocket 72. The numbered disc can be a simple disc of sheet material such as stiff paper or paperboard, optionally carrying the colors, logo or other indicia of the hotel on the reverse side, or it can be a peelably removable adhesive label placed upon an incentive disc or token (not shown here). Multiple adhesive labels can be used upon such discs. Such a token could take a number of forms, such as a gaming chip, souvenir badge, token redeemable in vending machines and/or slot-type gaming devices, or a souvenir coin such as produced at Mardis Gras celebrations. A coin of the latter type could be custom imprinted with the theme or identity of any affinity group, such as a particular tour, convention, reunion or the like. In a variation on this theme, the disc could be a confection such as a foil-wrapped “coin” of chocolate, candy mint or wafer, or a stick of chewing gum. As shown in FIG. 11D, the room number insert 74 in such a slotted pouch need not be a disc, but could take a fanciful shape such as a leaf (shown here) or other shape symbolizing the hotel or other establishment, or, e.g. shapes resembling the symbols of the suits of playing cards (hearts, clubs, etc.) or representing theme park characters.

FIGS. 11E and 11F illustrate the use of a strip of paper or other foldable sheet material 78, preferably fairly stiff, folded over the card key 11 in pocket 72 of keyholder card 70 for providing the room number. Strip 78 could also have one end inserted into slot 76. The user must remove the strip 78 from card key 11 to use same. As shown in FIG. 11F, the removable strip 78 can be perforated (78A) to allow the guest to remove a smaller segment containing the room number, the remainder being inscribed with the hotel name and other decorative materials to provide an attractive souvenir bookmark.

FIG. 11G ilustrates a card key 11 which is retained inside an open pocket 72 in a keyholder card 70 by a peelable adhesive label 80 containing the hotel name and resembling a classic wax seal as used in sealing correspondence or official documents. This label (or an actual melted wax seal stamped with the hotel name, in luxury or prestige establishments) holds in place a small detachable card or slip 82 containing the room number, at the same time retaining card key 11 in pocket 72. In a simpler version of this approach, the room number label can be a slip of paper at least partially coated on the reverse side with an easily peelable adhesive (such as in the Post-ItTM labels marketed by 3M company). Such a slip can be easily placed inside a wallet, notebook, appointment calendar or the like to adhere in place rather than placed directly inside a pocket.

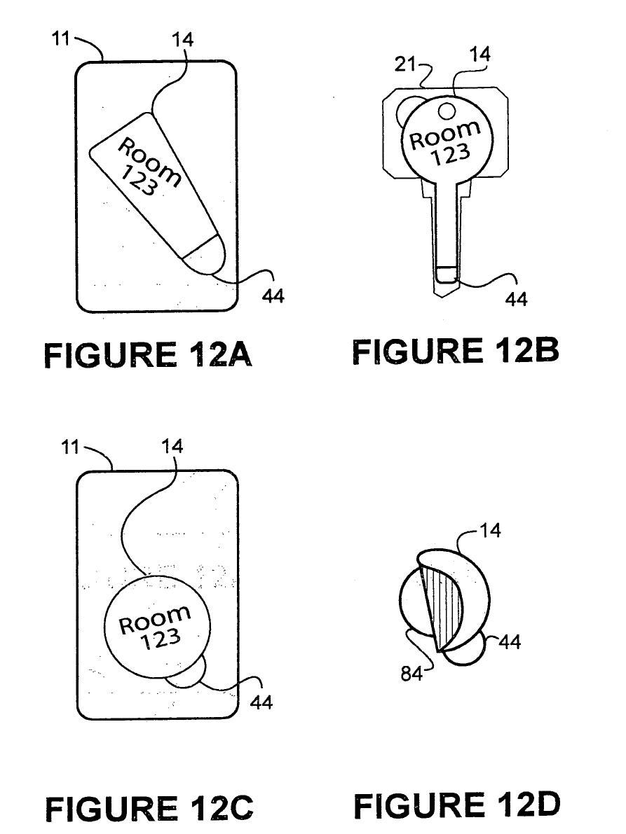

FIGS. 12A, 12B and 12C illustrate various means of adhering a peelable adhesive tab 14 containing the room number directly to a key (e.g., a card key 11 as in FIG. 12A or a flat metal key 21 as in FIG. 12B) with a gelatinous adhesive which is easily removable from both key and label after they are separated. This requires the room number label (and security device) to be separated from the key 11 before use. Labels 14 preferably include a pull tab 44, as shown in FIGS. 12A, 12B and 12C. The peelable room number label 14 can cover at least one token, souvenir or numbered ticket for a prize drawing, shown schematically in FIG. 12D as disc 84. Multiple layers of such flat tokens and labels can be provided to provide increased incentives for removing all the labels, keeping the key and room number separate. Such labels can be used to promote the hotel or related activities through advertising and premiums, and encourage the guest to retain them for future use. For example, in addition to coupons which may be redeemed for premiums or discounts at the hotel, related activities, restaurants and the like, the labels can contain taxi directions to the hotel and/or restaurants. Such “taxi cards” can be very useful in major foreign cities where unusual alphabets are used and/or street addresses are obscure, such as Tokyo or Bangkok.

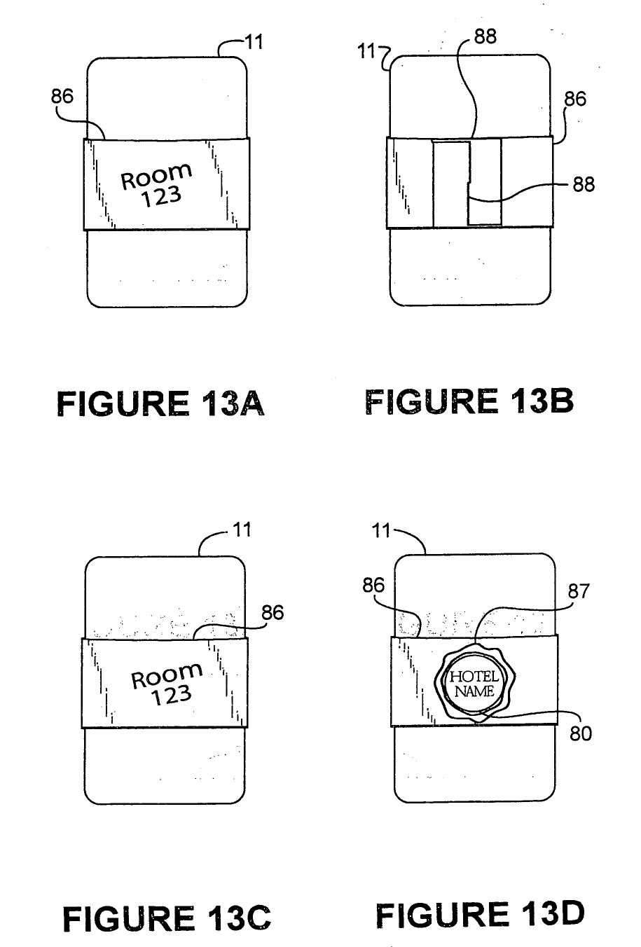

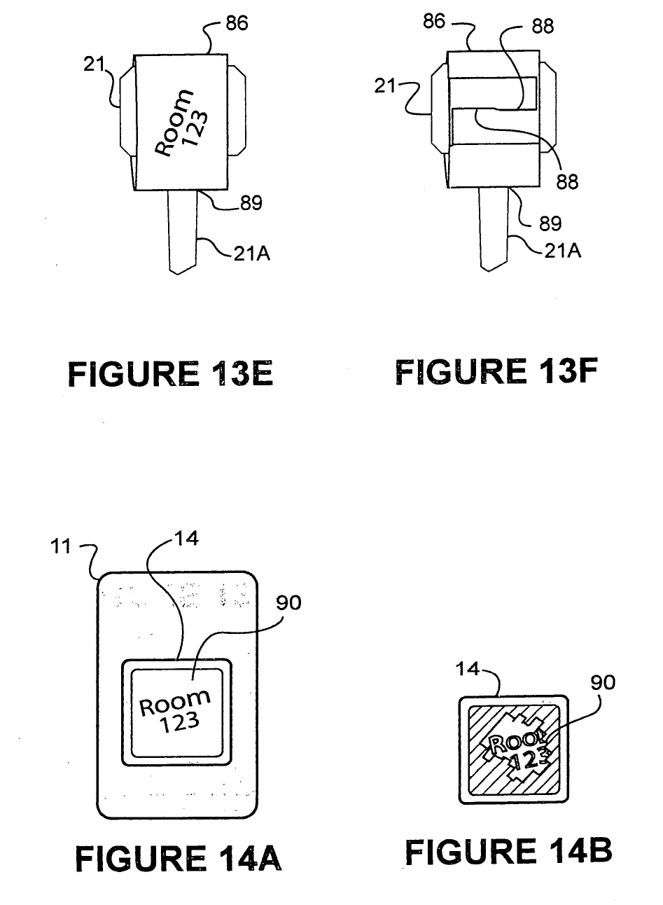

FIGS. 13A through 13F illustrate the use of paper strips marked with a room number and arranged to form a sleeve around a card key 11 or conventional flat metal key 21. In FIGS. 13A and 13B the strip 86 contains die-cut slots 88 which permit the ends of the strip to be interlocked on the reverse side of the keycard (FIG. 13B) to form the sleeve. FIGS. 13C and 13D illustrate an arrangement in which the ends 87 of the strip 86 containing the room number are fastened together with an adhesive seal 80 resembling an imprinted wax seal containing the hotel name (or a real wax seal, as described above). Optionally, seal 80 can extend beyond the sides of strip 86 to adhere same to card key 11. FIGS. 13E and 13F illustrate a room number slip 86 like that of FIGS. 13A and 13B which contains a slot 89 (not visible here) into which the shank 21A of metal key 21 can be inserted. The ends of the strip then can be folded around the head of the key, with die-cut slots 88 at the ends used to interlock the ends to form a sleeve around the head of the key. In all the cases described, the room number slip 86 must be removed to allow use of the key.

FIGS. 14A and 14B illustrate the use of opaque scratch-off coatings 90 which can be applied to at least one peelable label 14 on a card key 11 or other key (or directly to such keys) to conceal a prize offer such as a prize drawing number or special discount. The room number can be inscribed directly upon the scratch-off coating, requiring that the guest memorize or record the number before removing the coating, or the room number can be inscribed upon a peelable label covering the scratch-off coating. FIG. 14B shows label 14 removed from the key, with coating 90 partially removed. Scratch-off coatings 90 can also be used to reveal advertising, combinations for space access or codes for prizes.

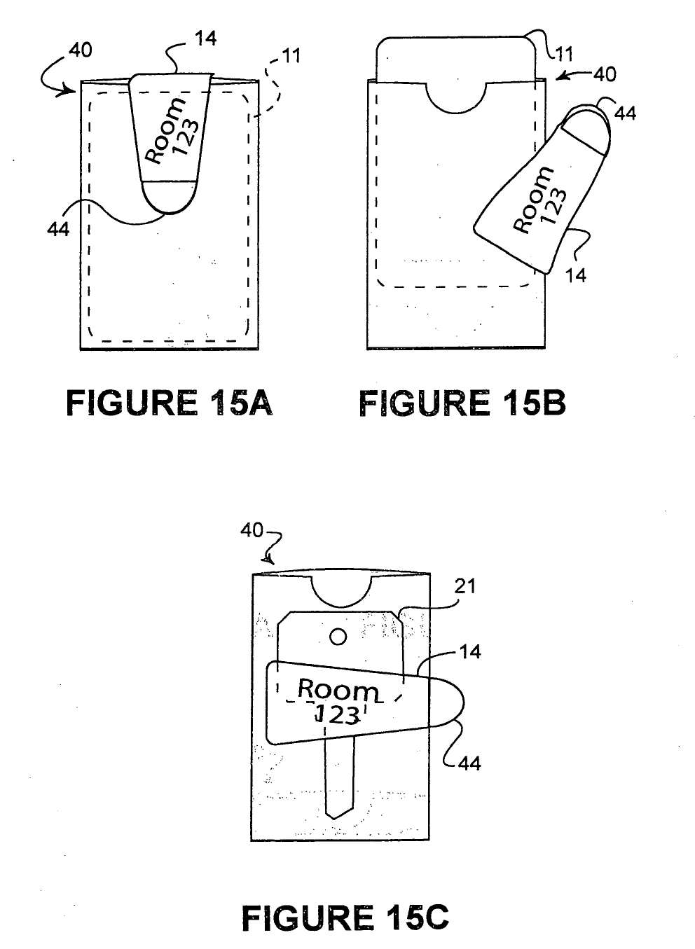

FIGS. 15A, 15B and 15C illustrate another manner of employing adhesive labels containing the room number to seal a key to a pouch-type key holder 40. In FIG. 15A peelable label 14 containing the room number is fastened over both sides of the open end of pouch 40 containing card key 11. Once removed by pulling tab 44, the label can be folded to adhere its adhesive surfaces together, leaving the room number visible, as shown in FIG. 15B. The card key can then be removed. A similar technique is used with the flat metal key 21 shown in FIG. 15C, except that adhesive label 14 is used to fasten key 21 to the outside of pouch 40, to ensure that the label is removed from the key and pouch before use.

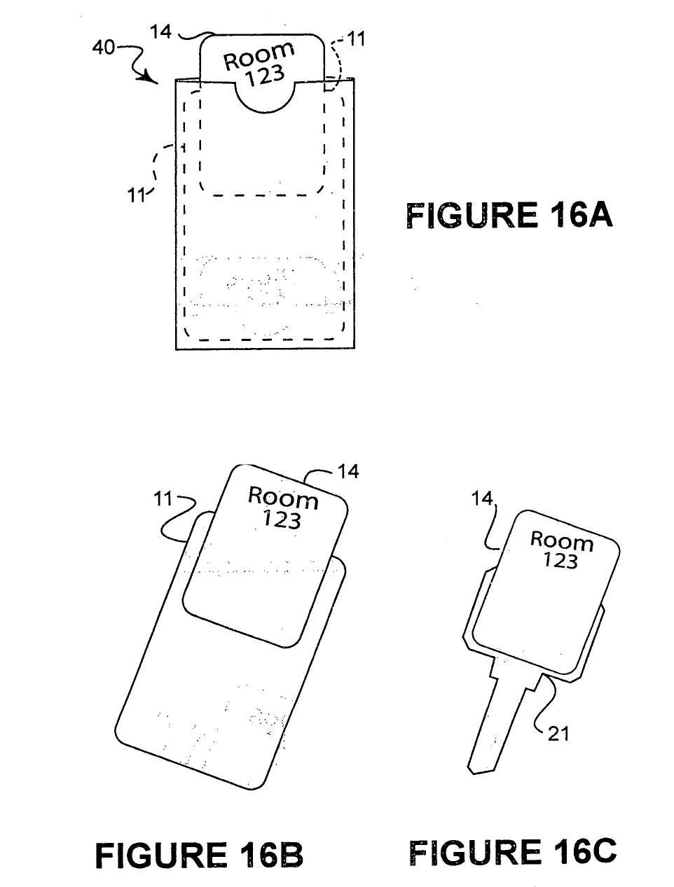

FIGS. 16A, 16B and 16C illustrate the use of an adhesive label 14 which is applied to a key (card-type 11 or flat metal 21) so that the portion containing the room number protrudes from the pouch-type key holder 40 when the key is inserted. As stated above, once the label 14 is removed from the key it can be folded so that the adhesive portions adhere together, leaving the room number visible. The label must generally be removed before using the key. The label 14 can be folded as described and kept separate from the key and holder, adhered to a personal notebook or scheduler or inside a wallet, or can be adhered to a portion of the holder, provided the key is kept separate therefrom.

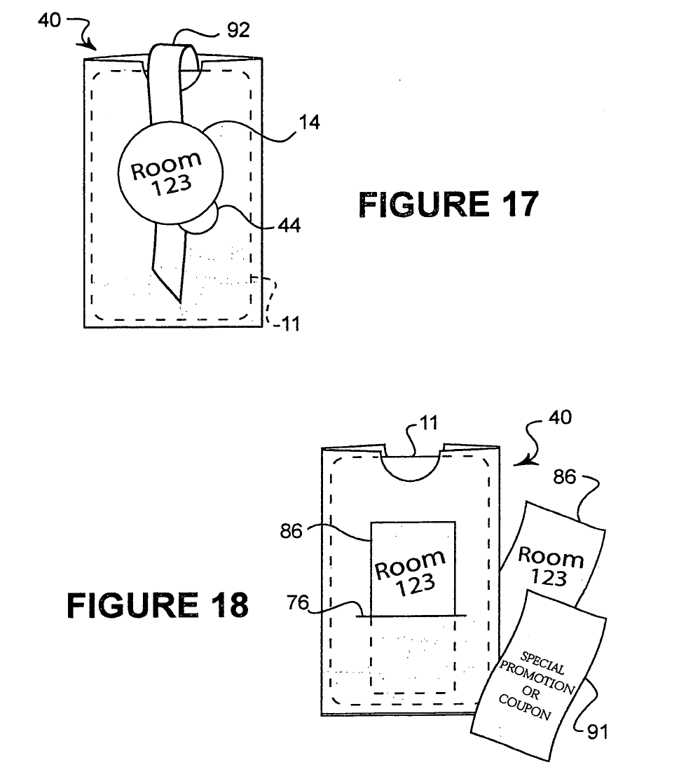

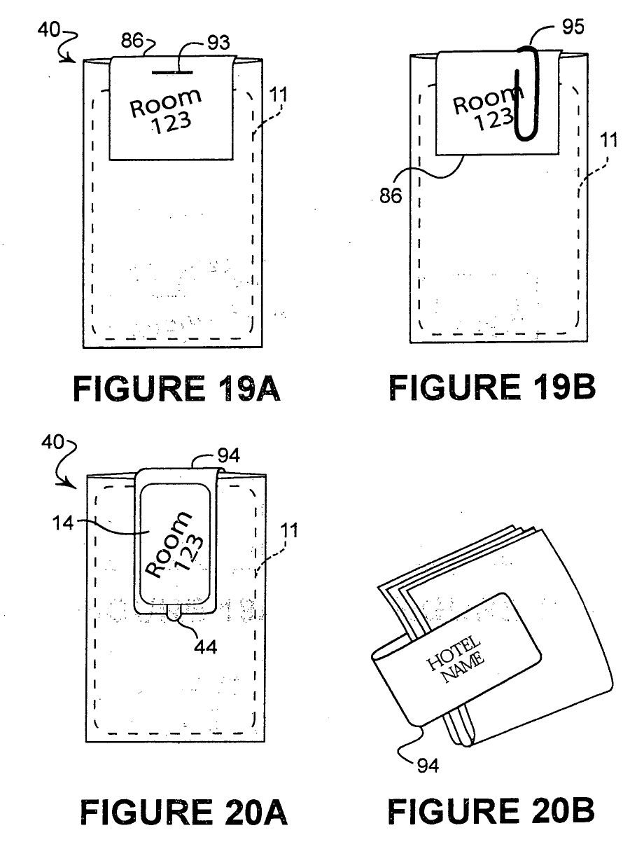

FIG. 17 illustrates the use of a decorative ribbon 92 in conjunction with a peelable label 14 (with tab 44) containing the room number to retain a card key 11 in a pouch-type key holder 40. Other methods of affixing a paper slip or strip 86 containing a room number to a key holder 40 for a card key 11 are shown in FIGS. 18, 19A and 19B. The strip can be inserted in a die-cut slot 76 in the key holder 40, and can include at least one coupon 91 or other promotional legend affixed on the back to encourage its removal and retention separate from the key. Similar paper strips 86 can be attached to the key holder with mechanical fasteners comprising staples 93 or paper clips 95, as illustrated in FIGS. 19A and 19B.

FIGS. 20A and 20B illustrate an adhesive label 14, preferably with pull tab 44, containing the room number attached to a money clip 94 imprinted with the hotel name or other suitable indicia. The label can be left on the clip, which is removed from the pouch key holder 40 to access the card key 11, or can be removed using tab 44 and carried separately from the money clip and key. The money clip can be a simple, functional model, or can be a quality product suitable as a souvenir of a stay at a luxury hotel, a cruise or group reunion.

Various useful personal or souvenir items which will fit within the pouch-style key holders illustrated above can be included as gifts for the guest, provided they do not adversely affect the magnetic properties of the card key. For example, small placques bearing photographic or decorative designs, wallet card-sized maps, language guides, guides to games of chance, magnifying lenses, mini-flashlights or the like can be provided. Costume jewelry pendants, brooches and/or chains could also be provided.

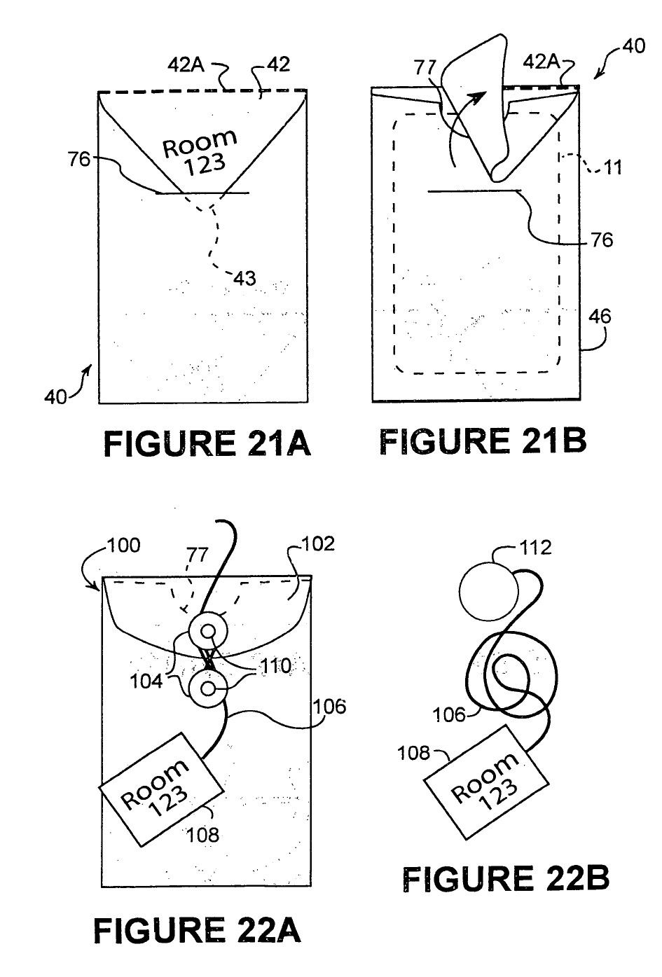

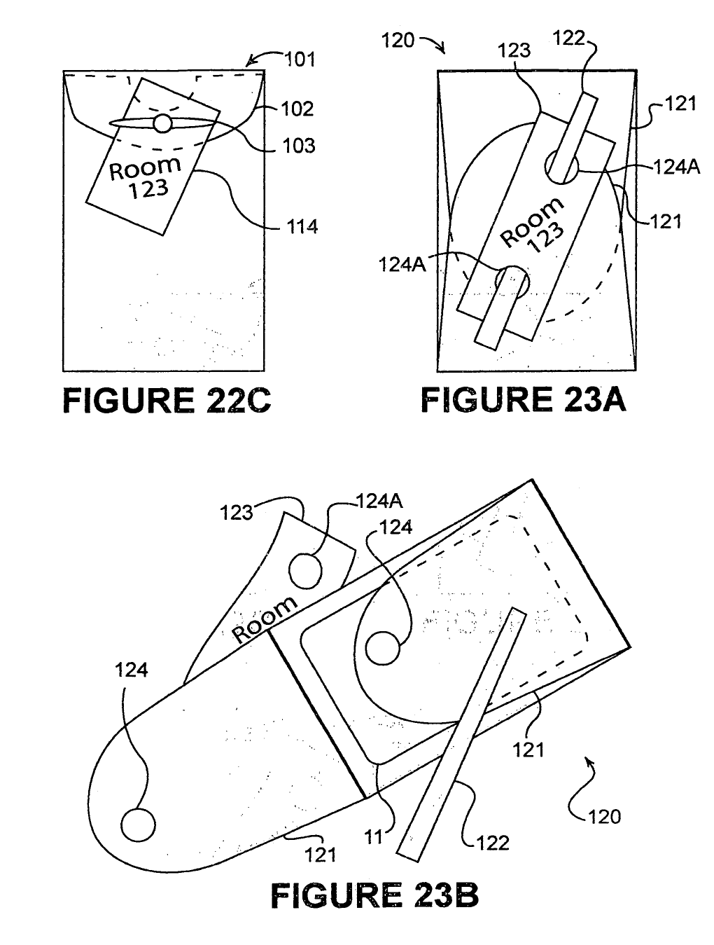

FIGS. 21A and 21B illustrate a pouch key holder 40 with perforated flap 42 with perforations 42A and a pointed end 43 inserted into a die-cut slot 76, which flap can be torn off for separate use after allowing access to the card key 11 inside. Optionally, such performated tabs and the various adhesive label devices described above can be designed to release a characteristic fragrance, in the same manner as the removable fragrance patches employed in magazine advertisements. FIGS. 22A and 22B illustrates the use of a string 106 to fasten flap 102 of an envelope key holder 100 closed by winding about both discs 104, which are affixed to the flap and envelope by fasteners 110. The string must be completely removed to open the flap and remove the key (metal or card key) inside. The string can then be removed from card 108 containing the room number, or the string may be formed into a loop to assist the guest in keeping it secure but accessible. Disc 112 schematically represents a souvenir, prize, token or other desirable item, including edible or scented items, to encourage the complete removal of string 106.

FIGS. 23A and 23B illustrate a trifold envelope key holder 120 which is held closed by a rigid or semi-rigid narrow strip of sheet material material 122 which is inserted through punched holes 124 in both tabs 121 of the envelope and in semi-rigid strip of sheet material 123 containing the room number. The key 11 (card or flat metal types) is folded into the envelope, the room number strip 123 positioned with its punched holes 124A matching the holes 124 in both tabs 121 of the envelope, and the narrow strip 122 passed through both sets of holes to seal the assembly. The guest need only slide the narrow strip 122 out of the holes to open the envelope and remove the key. The room number strip 122 can then be kept separate from the key. The rigid narrow strip 122 can be a novelty item imprinted with the hotel name, logo or the like and suitable for uses such as stirring a drink, or could be a wrapped edible item or cinnamon stick for flavoring drinks.

FIG. 23C illustrates the use of a small clasp envelope 101 as a key holder, the room number card or slip 114 being fastened outside flap 102 of envelope 101 by the clasps 103. In opening the envelope, the guest will remove the room number slip for use separate from the key and key holder. In addition to the closure means described, the pouch, envelope or folder holders can be provided with reusable closure means comprising hook-and-loop fabric combinations, frictional closures (such as Zip-LocTM), magnetic closures, drawstrings, laces and other suitable means for repeatedly opening and closing the holders.

Although the present invention has been described above by focusing on a preferred embodiment of a removable security device to facilitate the separate and secure carrying of a hotel guest's room number and the room key, the inventive concept can be extended to almost any arrangement where it is desirable to keep a convenient record of a space number and access means such as a key, code or combination both separate and secure. With these means separated, the loss of one or the other may cause inconvenience, but not allow intruders access to the designated space. The loss of a room key with a holder or other documentation of the room number could be disastrous unless the key code or other access means are changed immediately. As described above, the holder for the key or other access means can be provided with a variety of useful or attractive features to encourage the guest or traveller to retain same, perhaps even after the stay or journey. The removable security device incorporating the room number or other location indicia can incorporate incentives based upon the room number and/or random numbers or other codes or symbols, including advertising materials, or combinations thereof, which can qualify the user to win chances in a drawing, other game of chance, discount programs with the hotel or common carrier, or even related companies.

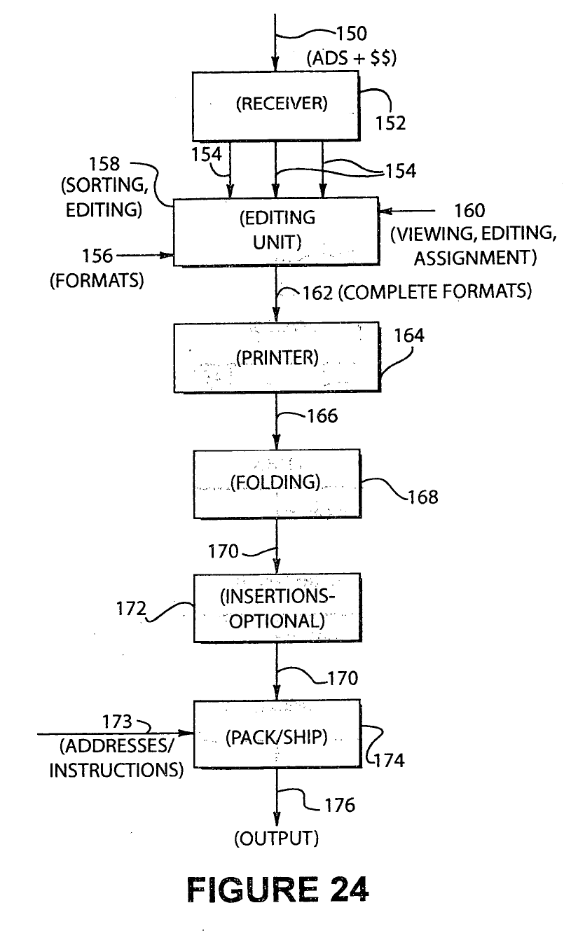

FIG. 24 is a schematic diagram illustrating another embodiment of the invention, a business method for selling advertising and incorporating it into holder assemblies and security devices of the invention, which are printed, folded and distributed to the facilities which have ordered the advertising. Advertising orders and financial authorizations 150 enter a receiver 152, which can encompass an office where telephone and direct orders and received and conventional and electronic mail (e-mail) are processed, electronic or computer means for receiving facsimile, file transfer protocol (FTP) or e-mail transmissions or other suitable means for receiving advertising orders for initial review and verification. Advertising copy may be received in immediately usable (“camera ready”) form or actually composed at this stage. The advertising can be directed to national, regional and local facilities or organizations, or various combinations thereof.

The resulting advertising copy is passed via multiple channels 154, including optical scanning into image or word processing document formats, e-mail or facsimile transmissions, FTP, keyboard inputs, computer drives for media such as diskettes and compact discs and other suitable means, into a computerized editing unit 158 for sorting and editing. This unit is preferably at lest partially computerized. Here the copy is viewed as necessary by an operator, edited and assigned (160) to appear in at least one document to be printed for a facility or organization ordering the advertising and access means holder assemblies, security devices and the like to be sent to the facility. Specific formats 156 for individual facilities are entered into unit 158 by suitable input means, and complete formats for the holder assemblies emerge at 162, preferably in electronic form. The units described in this schematic diagram need not be colocated, but can be linked by various suitable electronic, optical or electrical connecting means such as telephone lines, cables, networks, wireless transmitter/receiver combinations and the like. For example, the advertising copy could be submited to one location, the holder assembly formats compiled in a second location and the holder assemblies printed remotely in at least one additional location.

The completed formats 162 for printing the holder assemblies are entered into printer 164, where suitable sheet material such as paper or card stock is printed for the holder assemblies. A suitable printer assembly is disclosed in U.S. Pat. No. 6,234,477, which is incorporated herein by reference. The printed stock 166 is physically transferred to a folding unit 168, which is preferably part of an assembly line, to be folded into the form of the holder assemblies. The folded holder assemblies 170 can optionally be passed to an insertion unit 172 where objects such as adhesive security devices, access devices, prizes, game pieces, rewards, souvenirs and the like can be inserted. Labels, flaps or closures for pouches and envelopes can be sealed at this time. At this point, sequentially numbered pieces for various types of games of chance, lotteries, etc. can be imprinted or inserted. The folded holder assemblies 170, including any insertions or additions, are then physically transferred to a computerized packing and shipping unit 174, where addresses and postage and/or shipping instructions 173 are entered and the orders for individual facilities are made up for shipment. Such computerized packing and shipping systems are well known in the art of mail order fulfilment systems. The completed packages 176 are then transferred to a postal system or picked up by a shipping company for final shipment. Thus, a complete system is provided for automated processing of advertising orders and their incorporation into the holder assembly/security device combinations of the invention, including suitable incentives as described above, plus packing and shipment to the individual facilities they were prepared for.

Clearly, numerous modifications and variations of the present invention are possible in light of the above teachings. It is therefore to be understood that within the scope of the appended claims the invention may be practiced in various embodiments other than those specifically described above.

1. A holder assembly for access means to a space, comprising a detachable or removably attachable security device comprising an identification portion associated with said space, said holder assembly comprising at least one incentive motivating the user to separate said identification portion from said access means and to keep them separate for security reasons.

2. The holder assembly of claim 1 wherein said access means is a magnetic or mechanical key or a combination comprising numbers and/or letters.

3. The holder assembly of claim 1 wherein said space is selected from the group consisting of hotel rooms, shipboard staterooms, railroad compartments, storage compartments and rental vehicles.

4. The holder assembly of claim 1 which comprises at least two panels of sheet material folded to form a compact booklet.

5. The holder assembly of claim 4, further comprising printed matter selected from the group consisting of maps, coupons, facility guides, transportation information, guides to games of chance, currency conversion tables, advertising, telephone directories and pictorial material.

6. The holder assembly of claim 4 which comprises at least one pocket or slot for holding said access means.

7. The holder assembly of claim 1 which comprises at least one envelope for containing said access means.

8. The holder assembly of claim 7 wherein said at least one envelope is sealed to contain said access means, and said identification portion must be removed to open said envelope and remove said access means.

9. The holder assembly of claim 1 which comprises at least one pouch for containing said access means.

10. The holder assembly of claim 9 wherein said security device is used to seal said pouch.

11. The holder assembly of claim 2 wherein said key is a magnetic card key.

12. The holder assembly of claim 2 wherein said key is a mechanical key.

13. The holder assembly of claim 1 wherein said space identification portion is detachable from said holder by tearing along perforations.

14. The holder assembly of claim 1 wherein said space identification portion is removable from said holder by peeling from at least one pressure-sensitive adhesive layer.

15. The holder assembly of claim 14 wherein the removal of said space identification portion reveals at least one game piece, prize coupon, advertisement, confection or souvenir.

16. The holder assembly of claim 1 which comprises instructions to the user to separate said space identification means from said access means to maintain security of access.

17. The holder assembly of claim 1 wherein said security device prevents the use of said access means until it is removed from said holder assembly.

18. Access means to a space in combination with a detachable or removably attachable security device comprising identification means for said space, said security device preventing use of said access means until removal.

19. The combination of claim 18, wherein said security device further comprises instructions to separate said security device from said access means.

20. The combination of claim 18 wherein said security deice prevents the use of said access means until its removal therefrom.

21. The combination of claim 18 wherein said access means are selected from the group consisting of card keys, mechanical keys and combinations for a combination lock imprinted upon suitable media and said security device comprises at least one component selected from the group consisting of peelable adhesive labels, strips of paper or fabric, cords and closures for a holder for said access means.

22. A method of producing and distributing at least one edition of portable holder assemblies for access means to a space, said assemblies comprising a detachable or removably attachable security device comprising an identification portion associated with said space, said method comprising steps of:
a) selling advertising for inclusion in at least one edition of said holder assemblies;
b) receiving, preparing or editing advertising copy therefrom;
c) entering said advertising copy into a sorting and editing system;
d) entering advertising copy for each said edition into space allocated within a prepared document format for printing holder assemblies for said edition;
e) printing the edited and completed documents onto suitable sheet stock and folding as required to produce finished portable holder assemblies;
f) optionally, inserting additional materials into said assemblies;
g) packing each edition of the finished assemblies for shipment to designated customers, and
h) distributing same to each customer in required quantities to be used in providing customers with portable holder assemblies comprising access means for numbered spaces and removable identification portions containing the space numbers.

23. The method of claim 22 wherein said sorting and editing system is at partially computerized.

24. The method of claim 23 wherein said advertising copy is entered into said sorting and editing system by means comprising at least one of optical scanning of images or word processing documents, importation of word processing documents, electronic mail, file transfer protocols, reading of optical or magnetic recorded media and keyboard entry.

25. The method of claim 22 wherein at least one edition of said holder assemblies is produced for at least one specific facility comprising a plurality of spaces.

26. The method of claim 22 wherein said holder assemblies comprise at least one incentive motivating the ultimate user to separate said identification portion from said access means to keep them separate for security reasons.

27. The method of claim 22 wherein access means for a space are inserted into each holder assembly of at least one edition thereof.

28. The method of claim 27 which further comprises processes of sealing said access means in said holder assemblies.

29. The method of claim 22 which further comprises processes of inserting rewards in said holder assemblies.

30. A portable holder assembly containing a key for a numbered hotel room, comprising at least two panels of card stock folded to form a booklet and comprising printed matter, with a removable security device containing the assigned room number, said holder including instructions and incentives for the guest to remove said room number portion and to keep same separate from said key for security reasons.

31. The holder assembly of claim 30 wherein said key is a magnetic card key or a mechanical key.

32. The holder assembly of claim 30 wherein said removable security device prevents the use of said key until removed.

33. The holder assembly of claim 30 wherein the removal of said removable security device facilitates access to at least one game piece, advertisement, prize coupon or souvenir.

34. A holder assembly for access means to a space, comprising a detachable or removably attachable security device comprising an identification portion associated with said space.
